(19) United States
(12) Patent Application Publication
(10) Pub. No.: US 2025/0215651 A1
(43) Pub. Date: Jul. 3, 2025

(54) Traffic Barrel Safe Stacking System

(71) Applicant: Michael Paul Macropoulos, Long Island City, NY (US)

(72) Inventor: Michael Paul Macropoulos, Long Island City, NY (US)

(21) Appl. No.: 17/868,097

(22) Filed: Jul. 19, 2022

(51) Int. Cl. E01F 9/654; B65G 57/00; B65G 57/16

(52) U.S. Cl. CPC E01F 9/654; B65G 57/005; B65G 57/165

(57) ABSTRACT

A safety article, including: a stackable hollow first article stackable with one or more other first articles having substantially the same dimensions, and a second article positioned inside and attached to the interior of the stackable hollow first article, wherein the second article tolerates stacking of two or more of the safety articles, and the second article prevents jamming together or sticking together of the two or more stacked safety articles by preventing the first articles from fully nesting.

### TECHNICAL FIELD

The present disclosure relates generally to an article that avoids traffic safety articles/devices from getting stuck together when they are stacked for storage between uses. More particularly, the present disclosure relates to a first article that avoids jamming of stacked second articles when the first article is strategically attached to one or more of the second articles.

### BACKGROUND

During vehicular roadway activities such as construction, maintenance, repair, paving, reconstruction, paint striping, lane closure, lane traffic rerouting, collision zones, and like operational roadway activities, high visibility safety articles such as safety barrels, safety drums, or safety cones can be used to define active work areas, worker zones, and to caution vehicle operators of such vehicular roadway activities. Often the safety drums, safety barrels, or safety cones are stackable. The stacking of these articles provide for enhanced compact transport, storage, distribution (i.e., field placement or deployment), and retrieval. The placement and retrieval is often done from a moving vehicle, with workers reaching onto the roadway to either grab the articles from the roadway and stack them on the truck, or quickly unstack and place them on the road surface. When the stackable high visibility safety articles are retrieved and restacked with one or more similarly dimensioned and shaped safety articles, the stacked articles can become jammed or stuck together. Separating the jammed or struck stacked articles might require intervention by a field operator, which wastes valuable time and energy. The present disclosure provides a modified safety article that avoids or prevents the jamming or sticking (“stack seizure”) between two or more like dimensioned stacked safety articles.

While the stackable prior art units may be suitable for the particular purpose employed, or for general use, they would not be as suitable for the purposes of the present disclosure as disclosed hereafter.

In the present disclosure, where a document, act, or item of knowledge is referred to or discussed, this reference or discussion is not an admission that the document, act or item of knowledge or any combination thereof was at the priority date, publicly available, known to the public, part of common general knowledge or otherwise constitutes prior art under the applicable statutory provisions, or is known to be relevant to an attempt to solve any problem with which the present disclosure is concerned.

While certain aspects of conventional technologies have been discussed to facilitate the present disclosure, no technical aspects are disclaimed and it is contemplated that the claims may encompass one or more of the conventional technical aspects discussed herein.

### BRIEF SUMMARY

The present disclosure provides a safety article, comprising: a stackable hollow first article stackable with one or more other first articles having substantially the same dimensions, and a second article positioned inside and attached to the interior of the stackable hollow first article, wherein the second article tolerates stacking of two or more of the first safety articles, and the second article prevents jamming together or sticking together of the two or more stacked safety articles.

The present disclosure also provides a method of preventing the safety articles from sticking together. Accordingly, the present disclosure describes employing a spacer to prevent the articles from fully nesting and thereby preventing stack seizure.

Accordingly, the present disclosure describes a modified safety article and a method of preventing the safety article from sticking together when stacked.

The present disclosure addresses at least one of the foregoing disadvantages. However, it is contemplated that the present disclosure may prove useful in addressing other problems and deficiencies in a number of technical areas. Therefore, the claims should not necessarily be construed as limited to addressing any of the particular problems or deficiencies discussed hereinabove. To the accomplishment of the above, this disclosure may be embodied in the form illustrated in the accompanying drawings. Attention is called to the fact, however, that the drawings are illustrative only. Variations are contemplated as being part of the disclosure.

### BRIEF DESCRIPTION OF THE DRAWINGS

In the drawings, like elements are depicted by like reference numerals. The drawings are briefly described as follows.

FIG. 1A is diagrammatic perspective view of a safety item, namely a prior art stackable barrel.

FIG. 1B is a diagrammatic perspective view of the stackable barrel, with parts broken away.

FIG. 1C is a side elevational view, with parts broken away, showing two of the prior art stackable barrels in a stacked configuration, wherein the barrels are fully nested and are stuck together at seize points.

FIG. 2 is an exploded view of the stackable barrel, being modified in accordance with the present disclosure.

FIG. 3 is a diagrammatic perspective view of the modified stackable barrel, with parts broken away, showing a spacer attached within the stackable barrel.

FIG. 4 is a side elevational view, with parts broken away, showing an exemplary short stack of two modified stackable barrels, having a circumferential gap or non-seizure zone created by the spacer within one of the barrels that prevents the barrels from fully nesting and thereby minimizes or eliminates the jam or seizure points shown in FIG. 1C.

FIG. 5A to FIG. 5C are diagrammatic perspective views that show examples of a two-piece or a two-ply spacer and alternative suitable fastener combinations.

FIG. 6A to 6C are diagrammatic perspective views that show examples of spacer construction variations.

The present disclosure now will be described more fully hereinafter with reference to the accompanying drawings, which show various example embodiments. However, the present disclosure may be embodied in many different forms and should not be construed as limited to the example embodiments set forth herein. Rather, these example embodiments are provided so that the present disclosure is thorough, complete and fully conveys the scope of the present disclosure to those skilled in the art.

### DETAILED DESCRIPTION OF THE PREFERRED EMBODIMENTS

In embodiments, the disclosure provides a safety article, comprising: a stackable hollow first article stackable with one or more other first articles having substantially the same dimensions; and a second article positioned inside and attached to the interior of the stackable hollow first article, wherein the second article tolerates stacking of two or more of the safety articles, and the second article prevents jamming together or sticking together of the two or more stacked safety articles.

The stackable hollow first article can be, for example, a barrel, a cone, and like articles having like geometries.

The stackable hollow first article can be, for example, an injected molded plastic, a blow molded foam, a natural or synthetic rubber, a polymer block, a wood block, and like materials, or a combination thereof.

The second article has physical dimensions that can allow, for example, stacking of two or more first articles and the second article blocks or interrupts seizure stacking of two or more stacked first articles. “Seizure stacking” refers to stacking of two or more first articles that results in the stacked articles that are not easily separable by applying simple axial forces such as an operator lifting or pulling on the topmost first article on the stack, on the bottommost first article on the stack, or both.

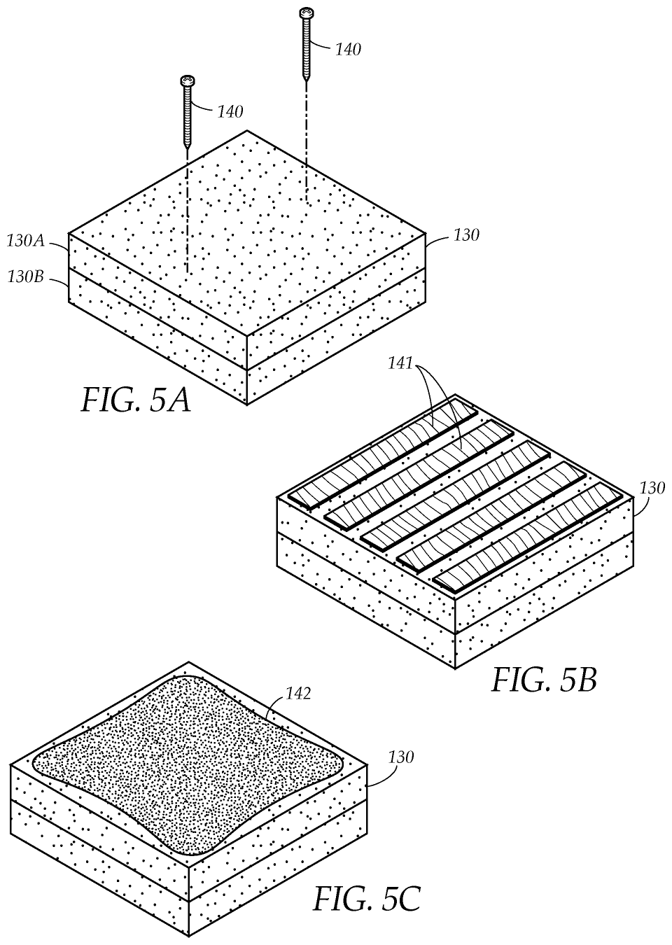

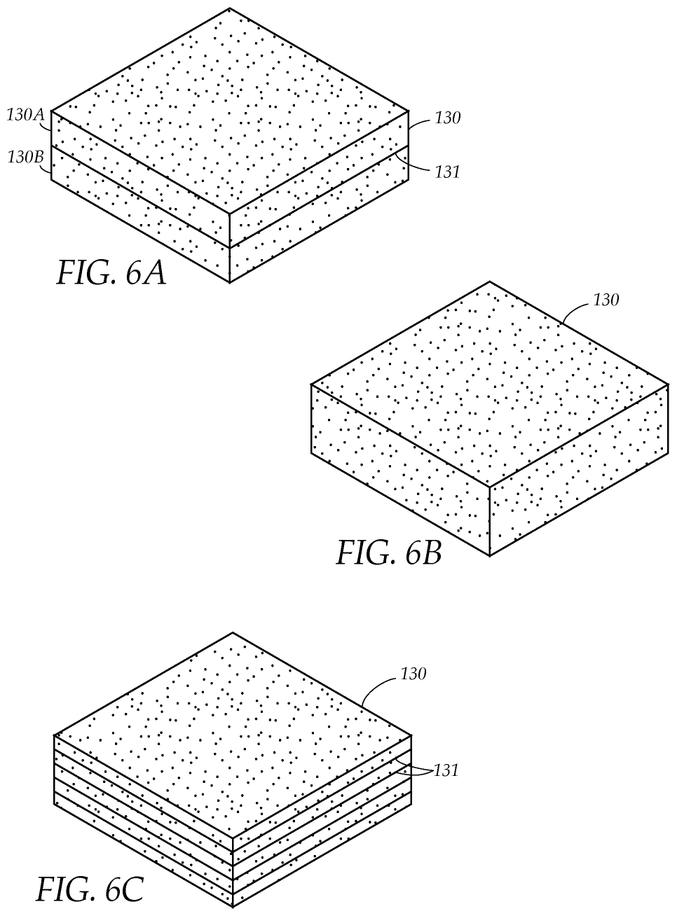

The second article can be, fastened to the interior of the first article with any suitable fastener, for example, a screw, a rivet, an adhesive, glue, a single or double sided tape, a pressure fit, a metal weld, a plastic weld, an ultrasonic weld, a hook-and-loop fastener (e.g., VELCRO® Brand and DuraGrip® fasteners such as straps, or coins and buttons with peel-and-stick adhesive), and like fasteners, or a combination thereof (See FIGS. 5A to 5C). In embodiments, the second article can be a stack of two or more second articles, such as two to four of the second articles that are joined together or laminated with, for example, a single or double sided adhesive tape, a single or double sided foam mounting tape (e.g., an acrylic adhesive tape available from McMaster-Carr (mcmaster.com)), a glue, a screw, a plastic weld, an ultrasonic weld, a hook-and-loop fastener, and like fasteners, or a combination thereof (See FIGS. 6A to 6C).

The safety article can further comprise, for example, a stack of from 2 to 30 safety articles free of stack seizure.

In embodiments, the disclosure provides a method of using the abovementioned modified safety article, comprising: stacking two or more safety articles in a stack while preventing them from sticking together by preventing them from fully nesting, and then subsequently unstacking two or more of the safety articles in the stack.

The stack can include, for example, 2 to 30 safety articles.

The stacking and the unstacking of the safety articles can be accomplished free of stack seizure between the adjacent or neighboring stacked safety articles in the same stack.

The stack can be, for example, vertical, horizontal, or both, and like orientations such a vertical stack that is inverted or a stack laid down on its side.

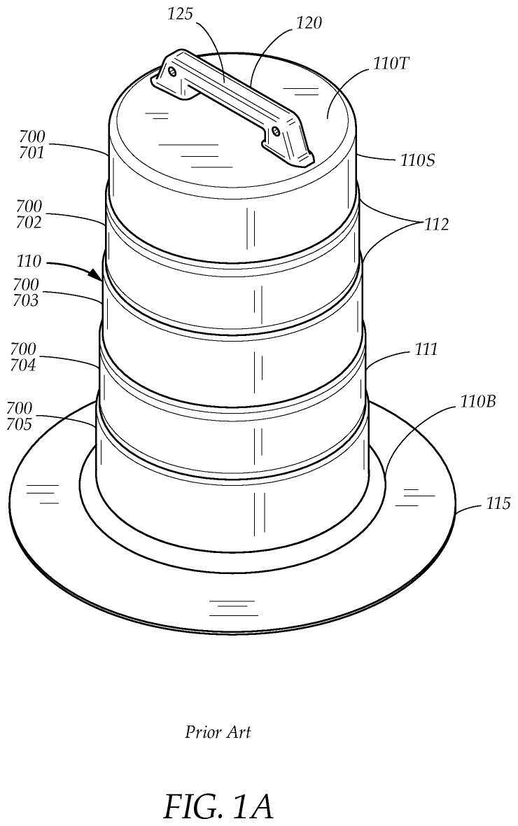

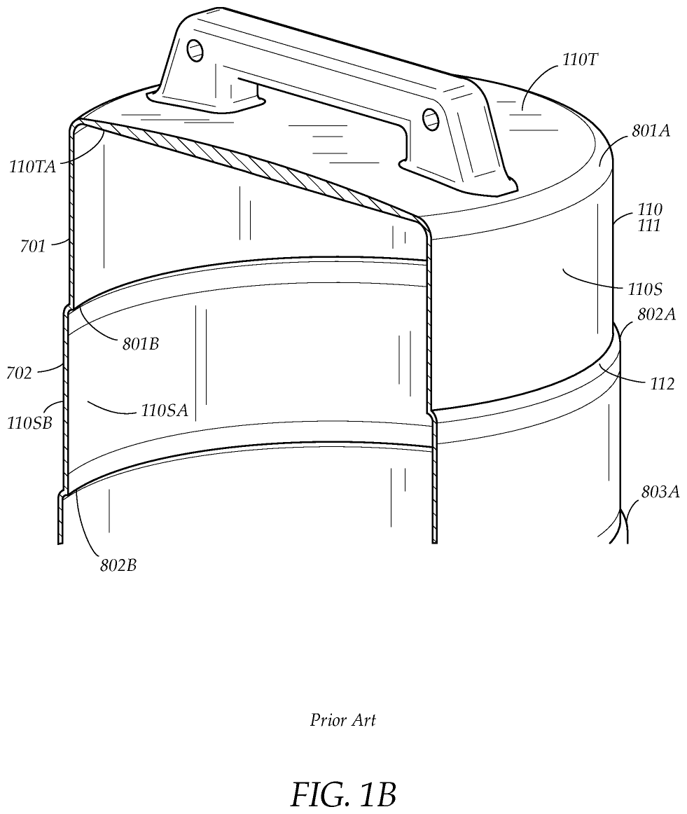

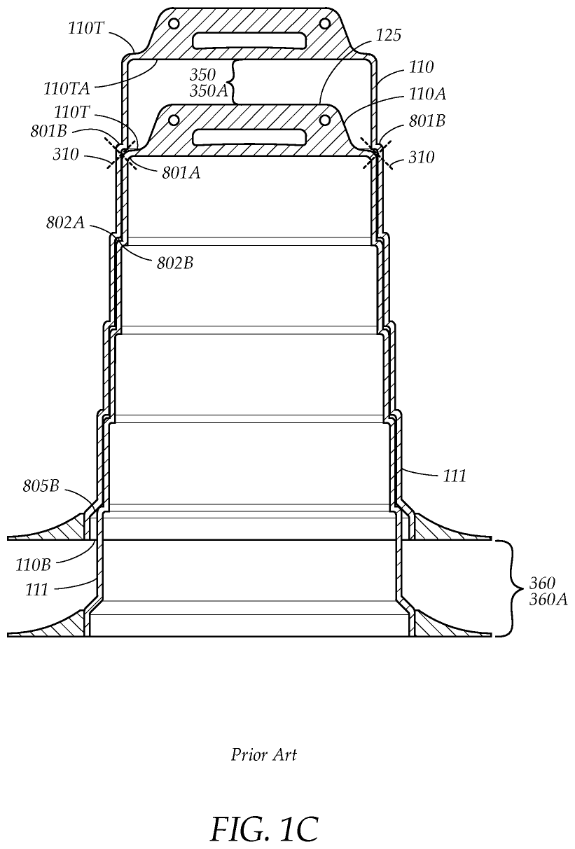

FIG. 1A is a diagrammatic perspective view of an exemplary, conventional safety item in the form of a stackable barrel 110 having a barrel shell 111 as shown in FIGS. 1A, 1B, and 1C. The barrel 110 shown in FIGS. 1A and 1B is of the type and size typically used by placing on a ground surface or roadway surface for dividing lanes, delineating construction areas, or otherwise diverting traffic, stands approximately a meter in height, and is designed to be stacked in groups, as discussed hereinafter, The barrel has a generally horizontal top panel 110T, and a bottom edge 110B that is open to facilitate stacking (as seen in FIG. 1C), and may have an extended base 115 attached near the bottom edge and extending circumferentially outward therefrom to provide broader contact with roadway or other ground surfaces. The barrel 110 may have a handle 120 protruding upwardly from the top panel, that may be affixed to the top panel 110T or the handle 120 may be a molded and integral protrusion extending therefrom. In this case, the handle 120 provides an uppermost point 125 of the barrel. While generally cylindrical, the barrel 110 has a side surface 110S that is tapered inwardly from the bottom edge 110B toward the top panel 110T to facilitate stacking, and is divided into stacking regions 700, that are separated by circumferential steps 112 that extend horizontally and diminish the diameter of the barrel at each of said steps 112. The steps 112 may also be ribs, and even be or include vertical grooves that are configured to facilitate stacking. The stacking regions 700 include an uppermost stacking region 701, a second stacking region 702, and subsequent stacking regions, 703, 704, 705.

Referring to FIG. 1B, the top panel 110T has an inside top surface 110TA. The side surface 110S includes an inside surface 110SA and an outside surface 110SB. Note that uppermost stackable region 701 has a first outer stacking corner 801A on the outside surface 110SB at the top panel 110, at a circumferential edge thereof, and the uppermost stackable region 701 also has a first inner stacking corner 801B connecting it to the second stacking region 702 at the inside surface 110SA. Accordingly, at the circumferential steps 112, there are outer stacking corners 802A, 803A, etc., and there are inner stacking corners, 801B, 802B, etc., with the locations of sequentially numbered corners such that the outer stacking corner is numbered one greater than the inner stacking corner at the same step 112, with the first of the outer stacking corners 801A at the top panel 110, and last of the inner stacking corners 805B located near the bottom edge 110B (see FIG. 1C). Thus, the first inner stacking corner 801B and first outer stacking corner 801A are not at the same height on the barrel. As will be seen with reference to FIG. 1C, the inner and outer corners are numbered for their correspondence when two barrels are stacked.

Referring to FIG. 1C, the barrels 110, 110A are stacked, and may be also referred to as an upper barrel 110 and lower barrel 110A, or as a first barrel 110 and second barrel 110A. When the shells 111 of these barrels are stacked, the top panel 110T of the lower barrel 110A is extended upwardly through the open bottom edge 110B, until the first outer stacking corner 801A of barrel 110 reaches the first inner stacking corner 801B of upper barrel 110. The second outer stacking corner 802A reaches the second stacking corner 802B, etc. Thus, the barrels 110, 110A fully nest within each other. When fully nested, the uppermost point 125 does not reach the top panel 110T. The uppermost point 125 of the secondary barrel 110A is separated from the inside top panel 110TA of barrel 110 by a clearance height 350 which in this case is a fully nested clearance height 350A. With barrels 110, 110A fully nested, the bottom edge of barrel 110A is separated from the bottom edge of barrel 110 by a bottom separation height 360 that is in this case a fully nested bottom separation height 360A.

Note that when barrels 110, 110A are fully nested as shown in FIG. 1C, they will often get stuck together at seizure points 310, wherein for example the first outer stacking corner 801A of barrel 110A is jammed within the first inner stacking corner 801B of barrel 110. When it is desired to separate or unstack barrels 110, 110A, significant force may be required.

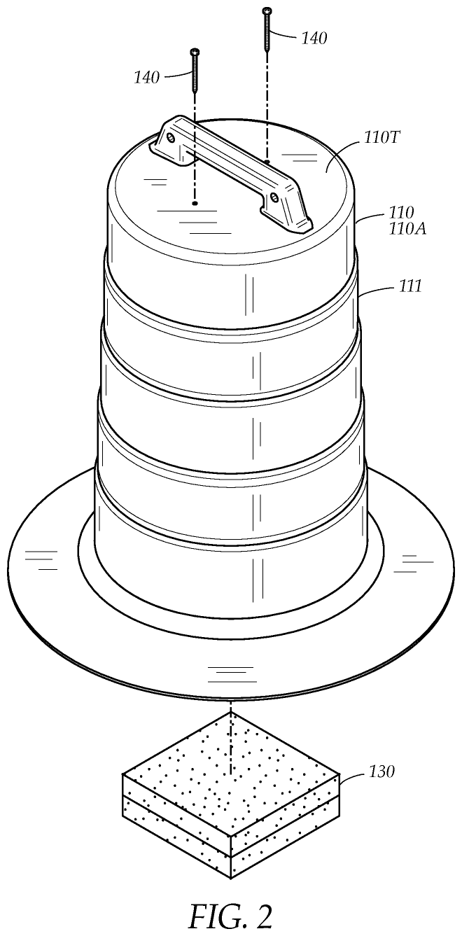

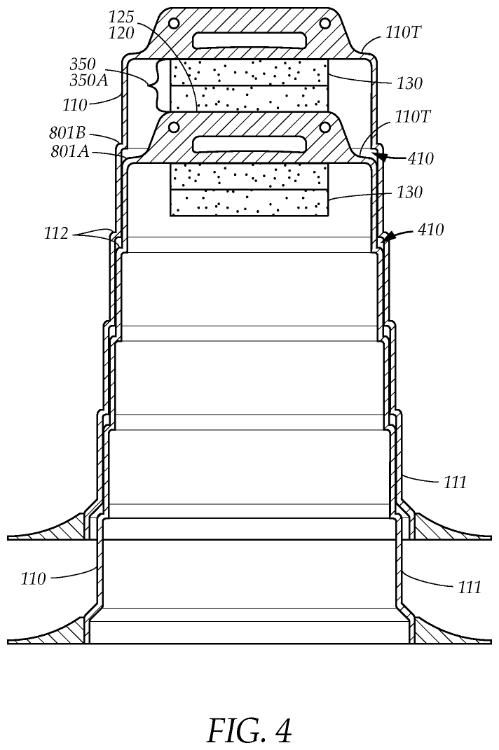

Accordingly, Referring to FIG. 2 and FIG. 4, in accordance with the present disclosure, each barrel 110,110A is modified and provided with a spacer 130 that is attached within the barrel shell 111 near the top panel 110T. The spacer 130 shown is a generally rectangular pad. The spacer 130 in barrel 110 prevents barrel 110A from fully nesting within barrel 110 by contacting the uppermost surface 125 of barrel 110A, altering the clearance height 350 to a non-nesting clearance height 350B, whereby barrel 110A cannot fully nest within barrel 110. In particular, when barrel 110 cannot reach the fully nested clearance height the first outer stacking corner 801A is prevented from reaching the first inner stacking corner 801B of barrel 110. In this example, the spacer 130 of barrel 110 contacts the handle 120 of barrel 110A to prevent barrel 110A from fully nesting upwardly into barrel 110.

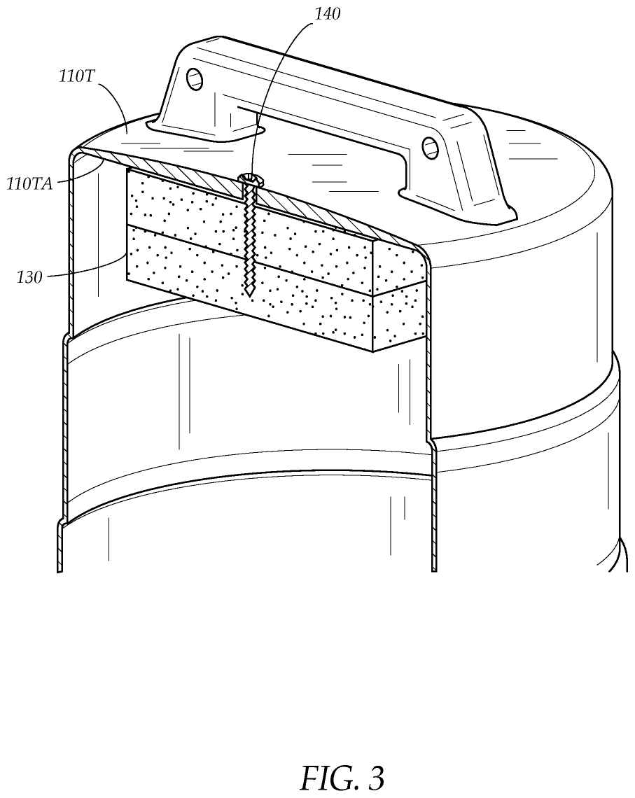

FIG. 2 illustrates an exploded perspective view of the exemplary stackable barrel 110 with an example of the spacer 130, provided as a spacer block, and at least one fastener 140. The spacer block may be provided as a generally rectangular prism shaped block of a foam like material that is lightweight, durable, and effectively creates the desired offset that prevents the fully nesting of barrels when another barrel is extending upwardly thereagainst. A preferred size for the spacer block is 12 by 12 inches with a thickness of approximately 4 inches. The fastener(s) 140 fasten the spacer 130 up inside the barrel 110 to the barrel shell 111 near the top surface 110T of the barrel 110. In particular FIG. 3 shows the spacer block 130 affixed against the inside top panel 110TA, fastened to the top panel 110T with the fastener 140, which in this case is a screw or bolt extending downwardly through the top panel 110T into the spacer 130. Other locations (not shown) for mounting or attaching the spacer to the drum interior include, for example, a center off-set on the top or handle surface, on one or more of the interior sidewalls, or preferably in close proximity to a structural rib, if present.

FIG. 4 shows an exemplary example short stack of two modified stackable barrels 110, 110A, having a circumferential gap 410 or non-seizure zone 410 at each of the steps 112, created by spacer 130 of barrel 110 that minimizes or eliminates jam or seizure points or seizure zones 310 shown in FIG. 1C. The spacer 130 added to the barrel shell 111 in modified barrel 110 allows seizure-free stacking with barrel 110A. Similarly, the spacer within drum 110A is available for further seizure-free stacking with another similarly shaped barrel (not shown) that may be subsequently inserted upwardly thereinto.

FIG. 5A to FIG. 5C show examples of a two-piece or a two-ply spacer block 130 and alternative suitable fastener combinations. FIG. 5A shows the two-piece or a two-ply spacer 130 that has two generally flat and rectangular spacer pieces 130A, 130B that are joined together by, for example, a suitable adhesive (not shown), to form a thicker rectangular item to adjust the separation height provided by the spacer unit or to provide logistic flexibility in manufacture. A suitable fastener is a screw fastener 140 that attaches to the spacer through at least one wall and on at least one surface of the barrel (intervening top surface 110T better seen in FIG. 3). FIG. 5B shows the two-piece or a two-ply spacer 130 as shown in FIG. 5A. An alternative suitable fastener is one or more double-sided adhesive strips 141 that attach to the spacer and mount the spacer to at least one interior surface of the barrel but not destructively (e.g., a drill or mold hole) through a drum wall. FIG. 5C show the two-piece spacer 130 or a two-ply spacer 130 as shown in FIG. 5A. A suitable fastener is an alternative adhesive material 142, such as a glue area or hook-and-loop fastener sheet, that is attached to the spacer and mounts the spacer to at least one interior surface of the barrel but not destructively through a barrel wall.

FIG. 6A to 6C show examples of spacer 130 construction and thickness variations. FIG. 6A shows the two-piece or a two-ply spacer 130 (illustrated in FIGS. 2, 3, and 4) that has pieces 130A, 130B are joined together by, for example, a suitable binder or adhesive 131 layer. FIG. 6B shows the monolithic or one-piece spacer 130 that is a single spacer piece that is free of a binder or an adhesive. FIG. 6C shows a multilayer spacer or a multi-ply spacer 130 that has five thin rectangular spacer panels that are laminated or glued joined together by, for example, four intervening layers of a suitable binder or adhesive 131.

Suitable raw materials for a spacer or a laminate layer for spacer construction can be, for example, polypropylene honeycomb 1.97 inch thickness (50 mm) 48″×96″ (e.g., from FGCI.com), polyethylene foam 2 inch thickness 24″×36″ (from McMaster-Carr), plastic coated or encased Styrofoam (e.g., an expanded polystyrene), preferably cut into 12 inch by 12 inch sheets, and doubled to attain a thickness of approximately 4 inches. The thickness will of course vary in accordance with the configuration of the barrel, such as the placement of the handle (not shown), and the amount of offset required to prevent full nesting. Accordingly, the thickness is chosen to alter the clearance height 350 when the modified barrels are stacked so that it is not the fully nested clearance height 350A seen in FIG. 1C, and is instead the non-nesting clearance height 350B seen in FIG. 4.

It is understood that when an element is referred hereinabove as being “on” another element, it can be directly on the other element or intervening elements may be present there between. In contrast, when an element is referred to as being “directly on” another element, there are no intervening elements present.

Moreover, any components or materials can be formed from a same, structurally continuous piece or separately fabricated and connected.

It is further understood that, although ordinal terms, such as, “first,” “second,” “third,” are used herein to describe various elements, components, regions, layers and/or sections, these elements, components, regions, layers and/or sections should not be limited by these terms. These terms are only used to distinguish one element, component, region, layer or section from another element, component, region, layer or section. Thus, “a first element,” “component,” “region,” “layer” or “section” discussed below could be termed a second element, component, region, layer or section without departing from the teachings herein.

Spatially relative terms, such as “beneath,” “below,” “lower,” “above,” “upper” and the like, are used herein for ease of description to describe one element or feature's relationship to another element(s) or feature(s) as illustrated in the figures. It is understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device can be otherwise oriented (rotated 90 degrees or at other orientations) and the spatially relative descriptors used herein interpreted accordingly.

Example embodiments are described herein with reference to cross section illustrations that are schematic illustrations of idealized embodiments. As such, variations from the shapes of the illustrations as a result, for example, of manufacturing techniques and/or tolerances, are to be expected. Thus, example embodiments described herein should not be construed as limited to the particular shapes of regions as illustrated herein, but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present claims.

In conclusion, herein is presented a stackable safety article and a method of use thereof. The disclosure is illustrated by example in the drawing figures, and throughout the written description. It should be understood that numerous variations are possible, while adhering to the inventive concept. Such variations are contemplated as being a part of the present disclosure.

What is claimed is:

1. A safety article, comprising:
at least two stackable barrels, including a first stackable barrel and a second stackable barrel, each stackable barrel having a barrel shell having an interior surface and an exterior surface, a top panel, an uppermost point, a bottom edge, and a generally cylindrical side wall between the top panel and bottom edge, the bottom edge is open, the barrel shells are sized and configured with interior corners and exterior corners that allow said barrel shells to fully nest with the uppermost point of the second barrel located at a fully nested clearance height from the top panel of the first barrel when the second panel is extended inside the first barrel and with the exterior corners of the first barrel resting against corresponding interior corners of the first barrel, and
a spacer, attached within the barrel shell of the first stackable barrel shell near the top panel, said spacer within the first stackable barrel preventing said second stackable barrel from fully nesting within the first stackable barrel by preventing the uppermost point of the second stackable barrel from reaching the fully nested clearance height and thereby preventing the exterior corners of the second barrel from reaching corresponding interior corners of the first stackable barrel.

2. The safety article of claim 1, wherein the spacer is a spacer block that is affixed to the top panel of the first stackable barrel.

3. The safety article of claim 2, wherein each stackable barrel is at least one meter in height, has a handle attached to the top surface, the handle having the uppermost point, wherein each stackable barrel is tapered inwardly from the bottom edge toward the top panel and has a plurality of steps that each have an outer corner and an inner corner.

4. A stackable barrel method, for stacking at least two stackable barrels, including a first and a second stackable barrel, while keeping the barrels from sticking together and requiring significant force to separate, each stackable barrel having a barrel shell having an exterior surface and an interior surface, a top panel, an uppermost point, a bottom edge, and a generally cylindrical side wall between the top panel and bottom edge, the bottom edge is open, the barrel shells are sized and configured with interior corners and exterior corners that allow said barrel shells to fully nest with the uppermost point of one of the barrels located at a fully nested clearance height from the top panel of another barrel it is extended inside and with its exterior corners resting against corresponding interior corners of said other barrel it is inside, comprising the steps of:
Affixing a spacer to the interior surface within the barrel shell of the first stackable barrel near the top panel;
Stacking the first and second stackable barrel by inserting the second stackable barrel upwardly into the bottom end of the first stackable barrel; and
Preventing the second barrel from fully nesting by preventing the uppermost point of the second barrel from reaching the fully nested clearance height by interfering the spacer with the uppermost point of the second barrel.

5. The stackable barrel method as recited in claim 4, wherein the top panel has an inside top surface, wherein the spacer is a block, and wherein the step of affixing the spacer to the interior surface within the barrel shell further comprises attaching the block to the inside top surface using a fastener.

6. The stackable barrel method as recited in claim 5, wherein the fastener is chosen from the group consisting of adhesive, a screw, a bolt, and a hook and loop fastener.
